(19) United States
(12) Patent Application Publication
(10) Pub. No.: US 2025/0196686 A1
(43) Pub. Date: Jun. 19, 2025

(54) WIRELESS CHARGING SYSTEM FOR ELECTRIC VEHICLE

(71) Applicants: Hyundai Motor Company, Seoul (KR); Kia Corporation, Seoul (KR); Seoul National University R&DB Foundation, Seoul (KR)

(72) Inventors: Euihoon Chung, Hwaseong-si (KR); Gyu Yeong Choe, Hwaseong-si (KR); Hyun-Wook Seong, Hwaseong-si (KR); Jungik Ha, Seoul (KR); Sunghyuk Choi, Seoul (KR)

(21) Appl. No.: 18/967,183

(22) Filed: Dec. 3, 2024

(30) Foreign Application Priority Data
Dec. 15, 2023 (KR) 10-2023-0183028

(51) Int. Cl. B60L 53/39; B60L 53/122; H02J 50/12; H02J 50/90

(52) U.S. Cl. CPC B60L 53/39; B60L 53/122; H02J 50/12; H02J 50/90; H02J 2310/48

(57) ABSTRACT

A wireless charging system for an electric vehicle can includes a transmitter including a transmission pad installed separate from the vehicle and configured for generating an electromagnetic field by receiving energy, and a receiver including a reception pad installed inside the vehicle and configured to be disposed to face the transmission pad, and configured for inducting a voltage by the electromagnetic field generated by the transmission pad and charging a battery of the electric vehicle, and the transmission pad can be provided to transmit a maximum output even though the transmission pad is formed to be asymmetric to the reception pad in a width direction of the vehicle.

### CROSS-REFERENCE TO RELATED APPLICATIONS

This application claims the benefit of Korean Patent Application No. 10-2023-0183028, filed in the Korean Intellectual Property Office on Dec. 15, 2023, which application is hereby incorporated herein by reference.

### TECHNICAL FIELD

The present disclosure relates to a wireless charging system for an electric vehicle.

### BACKGROUND

In general, a wireless charging system for an electric vehicle consists of a transmitter installed outside a vehicle containing a transmission pad and a receiver including a reception pad and installed inside the vehicle.

The transmitter converts energy supplied from a system into a high-frequency AC signal through a switching device, and delivers the high-frequency AC signal to the transmission pad. A voltage is induced by the reception pad by a time varying magnetic field generated by the transmission pad. A power conversion circuit mounted on the receiver converts power received through the reception pad into a DC voltage to charge a high-voltage battery. In this case, a magnitude and efficiency of wirelessly transferred power varies depending on an alignment state (a vertical direction Z, a longitudinal direction X, and a transverse direction Y) between the transmission pad and the reception pad.

In a wireless charging system for an electric vehicle in related art, the reception pad is primarily mounted on a lower portion of the vehicle. In this case, the alignment state between the transmission pad and the reception pad can vary depending on a parking state/a cargo loading state, and this causes a deviation of a wireless charging performance, such as output, efficiency, etc.

Even if alignment deviations exist within allowable vertical and longitudinal/transverse distance ranges, a volume/weight/cost/complexity of a resonance pad and a compensation circuit increase for energy delivery.

Therefore, a system in which a vertical distance between the transmission and reception pads is adjusted and maintained constant through a method of coupling an actuator to the transmission pad, or a system in which the vertical distance between the transmission and reception pads is maintained constant through a method of coupling the actuator to the reception pad and elevating the actuator coupled to the reception pad, is proposed, but when a longitudinal/transverse alignment error is considered, a position control for a maximum of 3 axes is required, so there is a problem in that the complexity of the actuator is greatly increased.

### SUMMARY

The present disclosure relates to a wireless charging system for an electric vehicle, and more particularly, to a wireless charging system for an electric vehicle, which includes a double pole resonant pad of an asymmetric structure.

Accordingly, an embodiment of the present disclosure can provide a wireless charging system for an electric vehicle in which a positional error may occur upon vehicle alignment for wireless charging, and in which a transmitter can be configured by a double pole pad, and a size of a transverse core can be configured asymmetrically to a reception pad by considering a transverse allowable deviation between a transmission pad and the reception pad.

An example embodiment of the present disclosure provides a wireless charging system for an electric vehicle, which can include: a transmitter including a transmission pad installed separate from the vehicle, and generating an electromagnetic field by receiving energy; and a receiver including a reception pad installed inside the vehicle, and disposed to face the transmission pad, and inducting a voltage by the electromagnetic field generated by the transmission pad and charging a battery, in which the transmission pad can be provided to transmit a maximum output even though the transmission pad is formed to be asymmetric to the reception pad in a width direction of the vehicle.

The receiver may include a power conversion circuit for converting a power received through the reception pad into a DC voltage.

The wireless charging system may further include an actuator installed inside the vehicle, and adjusting a pore (vertical distance) between the transmission pad and the reception pad.

The pore between the transmission pad and the reception pad may be adjusted as an interval of 100 mm or less.

The wireless charging system may further include a parking block installed separate from the vehicle, and adjusting a longitudinal (x-axis) alignment of the vehicle.

The transmission pad may have a double pole resonant pad structure, and the double pole resonant pad structure may include a first magnet formed to protrude in a height direction of the vehicle, and wound with a first coil, and a pair of second magnets coupled to ends of the first magnet in a form to extend vertically to a protruding direction of the first magnet.

The reception pad may include a third magnet opposite to the first magnet, and formed to protrude toward the first magnet, and wound with a second coil.

The wireless charging system may further include a pad position sensor sensing positions of the transmission pad and the reception pad in a vehicle width direction.

The double pole resonant pad structure may be designed to satisfy a maximum transfer power upon short-distance wireless charging.

An example embodiment of the present disclosure can provide a shape design method of a resonant pad of a wireless charging system for an electric vehicle, which can include: selecting a shape of a pad; analyzing a magnetic circuit; selecting the maximum transfer power upon a maximum pore (vertical distance) of the transmission and reception pads, and misalignment; selecting a magnetomotive force NI considering a loss per unit volume; calculating a polar area; selecting a distance between poles; setting the transmission pad asymmetrically in the vehicle width direction; and validating through a simulation.

In the selecting of the shape of the pad, the transmission pad and the reception pad may be formed asymmetrically, and the transmission pad may have a double pole resonant pad structure.

The analyzing of the magnetic circuit may be performed by magnetic equivalent circuit induction of the transmission and reception pads by an inductive power transfer (IPT) ruling equation.

In the selecting of the maximum transfer power upon the maximum pore and the misalignment of the transmission and reception pads, the maximum transfer power can be modeled as Equation 1 below by applying magnetic inductances L_{P} and L_{S}, and a mutual inductance M.

$${V}_{OC} {I}_{SC} = ω ( {M}^{2} / {L}_{S} ) {I}_{P}^{2} = ω {L}_{P} {k}^{2} {I}_{P}^{2} \qquad [ Equation 1 ]$$

In the selecting the magnetomotive force NI considering the loss per unit volume, the magnetomotive force may be modeled as Equation 2 below.

$${N}_{1} {I}_{P} = {kl}_{g} {B}_{max} / {μ}_{0} \qquad [ Equation 2 ]$$

In the calculating of the polar area, the polar area may be modeled as Equation 3 below.

$$A = 2 {l}_{g} {P}_{uc} / k ω ( {N}_{1} {I}_{P} ) 2 {μ}_{0} \qquad [ Equation 3 ]$$

In the selecting of the distance between the poles, the distance between the poles maybe set through an FEM simulation.

In the setting of the transmission pad asymmetrically in the vehicle width direction, a second magnet at one side may be set to be longer by 200 mm in the vehicle width direction.

In the validating through the simulation, it may be validated whether a target maximum transfer power is satisfied in a misalignment condition of the transmission and reception pads in the vehicle width direction.

According to an example embodiment of the present disclosure, a transmitter can be configured by a double pole pad, and a size of a transverse core of the transmission pad can be configured asymmetrically to (or wider than) a reception pad by considering a transverse allowable deviation between a transmission pad and the reception pad for wireless charging of an electric vehicle, so the need for transverse movement of the vehicle can be removed or minimized for positional alignment of the transmission and reception pads, thereby simplifying a charging system.

Stress of a customer for positional alignment of the transmission and reception pads can be minimized, and system design robust to misalignment can be possible.

By maintaining pores between the transmission and reception pads in a short distance, volumes of the transmission and reception pads can be reduced, and a power transmission capability can be increased and charging efficiency can be enhanced.

An actuator for reduction of the pores between the transmission and reception pads can be provided to reduce installation cost of the transmitter or the receiver, and minimize the complexity of the actuator for positional control through asymmetric design of the transmission pad.

Use of a variable element in a receiver-side compensation circuit can be minimized by minimizing a circuit variable change according to a misalignment situation to simplify a receiver structure, and reduce cost and a receiver volume.

### BRIEF DESCRIPTION OF THE DRAWINGS

FIG. 1 is a side view schematically illustrating a wireless charging system for an electric vehicle according to an example embodiment of the present disclosure.

FIG. 2 is a front view schematically illustrating the wireless charging system for an electric vehicle according to an example embodiment of the present disclosure.

FIG. 3 is a diagram schematically illustrating transmission and reception pads of a wireless charging system for an electric vehicle according to an example embodiment of the present disclosure.

FIG. 4 is a diagram illustrating a magnetic equivalent circuit model of transmission and reception pads of a wireless charging system for an electric vehicle according to an example embodiment of the present disclosure.

FIG. 5 is a flowchart illustrating a shape design method of a resonant pad of the wireless charging system for an electric vehicle according to an example embodiment of the present disclosure.

FIG. 6 is a diagram illustrating a mutual combination model equivalent circuit of the transmission and reception pads for magnetic circuit analysis in a shape design method of the resonant pad in a wireless charging system for an electric vehicle according to an example embodiment of the present disclosure.

FIG. 7 is a diagram illustrating a loss per core unit volume for magneto-optic selection in a shape design method of a resonant pad in a wireless charging system for an electric vehicle according to an example embodiment of the present disclosure.

FIG. 8 is an example diagram for calculating a polar area in a shape design method of a resonant pad in a wireless charging system for an electric vehicle according to an example embodiment of the present disclosure.

FIG. 9 is an example diagram for selecting a distance between poles in a wireless charging system for an electric vehicle according to an example embodiment of the present disclosure.

FIGS. 10 to 12 are example diagrams, each for validation through a simulation in a shape design method of a resonant pad in a wireless charging system for an electric vehicle according to an example embodiment of the present disclosure.

FIG. 13 is a diagram illustrating maximum transfer power in a misalignment situation in a shape design method of a resonant pad in a wireless charging system for an electric vehicle according to an example embodiment of the present disclosure.

FIG. 14 is a diagram illustrating a case of applying only an asymmetric design without an actuator in a wireless charging system for an electric vehicle according to an example embodiment of the present disclosure.

FIG. 15 is a diagram illustrating a case of applying an asymmetric design by using an actuator in a wireless charging system for an electric vehicle according to an example embodiment of the present disclosure.

FIG. 16 is a flowchart illustrating a wireless charging process in a case of using a Y-axis positional sensor in a wireless charging system for an electric vehicle according to an example embodiment of the present disclosure.

### DETAILED DESCRIPTION OF ILLUSTRATIVE EMBODIMENTS

Hereinafter, example embodiments of the present disclosure will be described more fully hereinafter with reference to the accompanying drawings such that an embodiment can be implemented by those skilled in the art. An embodiment of the present disclosure may be implemented in various different forms and is not necessarily limited to example embodiments described herein.

In addition, in various example embodiments, components having a same configuration can be described in an example embodiment using a same reference numeral, and in other example embodiments, only a different component from an example embodiment may be described.

The drawings can be schematic and not illustrated according to a scale. The relative dimensions and ratios of the parts in the drawings can be exaggerated or reduced in their sizes for clarity and convenience in the drawing, and any dimensions can be just example, not necessarily limiting. In addition, a same structure element or component in two or more drawings can be used to show similar characteristics of a same reference numeral. When any part of or referred to as being “on”, “over” the other part, which might be directly on or over the other parts or may be a different part involves therebetween.

Various transformations of the diagrams can be expected. Therefore, the example embodiments are not necessarily limited to a specific form of the illustrated area, and for example, can also include a modification of the form of manufacture.

Hereinafter, example embodiments of the present disclosure, which can provide a wireless charging system for an electric vehicle, will be described in detail with reference to the accompanying drawings.

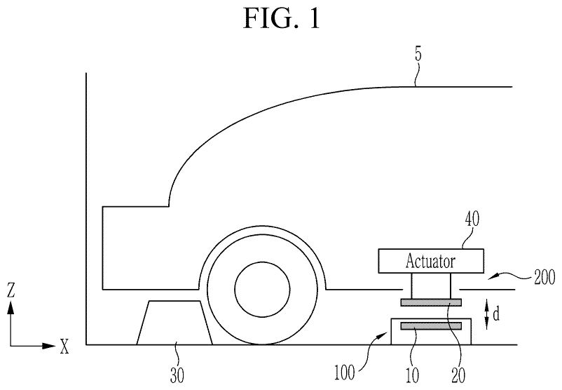

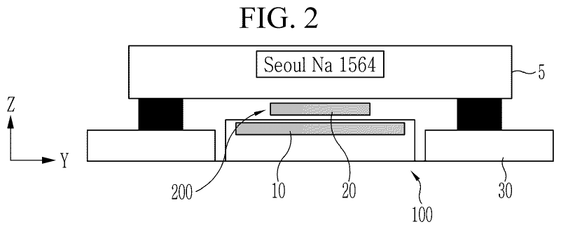

FIG. 1 is a side view schematically illustrating a wireless charging system for an electric vehicle according to an example embodiment of the present disclosure. FIG. 2 is a front view schematically illustrating a wireless charging system for an electric vehicle according to an example embodiment of the present disclosure.

Referring to FIGS. 1 and 2, the wireless charging system for an electric vehicle according to an example embodiment of the present disclosure can include a transmitter 100 installed separate from a vehicle 5 and a receiver 200 installed inside the vehicle 5.

The transmitter 100 can include a transmission pad 10, and the transmission pad 10 can receive energy from a power system separate from the vehicle 5 to generate an electric field. The receiver 200 can include a reception pad 20 disposed to face the transmission pad 10. The reception pad 20 can induce a voltage by the electric field generated by the transmission pad 10 to charge a battery of the vehicle 5. The receiver 200 may include a power conversion circuit that can convert power received through the reception pad 20 into a DC voltage.

The wireless charging system for the electric vehicle 5 may further include an actuator 40 installed inside the vehicle 5. The actuator 40 can adjust a pore d between the transmission pad 10 and the reception pad 20. The actuator 40 can be connected to the reception pad 20 to allow the reception pad 20 to move up and down. The actuator 40 can adjust a pore d from the transmission pad 10 fixed to the surface separate from the vehicle 5. The pore d can be adjusted at an interval of approximately 100 mm or less, for example.

The wireless charging system for the electric vehicle 5 may further include a parking block 30. The parking block 30 may be configured in a form to protrude from the ground at a predetermined height. The parking block 30 can be in contact with a tire of the vehicle 5 to limit forward and/or backward movement of the vehicle 5. The parking block 30 can fix movement of the vehicle 5 to perform forward and/or backward alignment of the vehicle 5 between the transmission pad 10 and the reception pad 20.

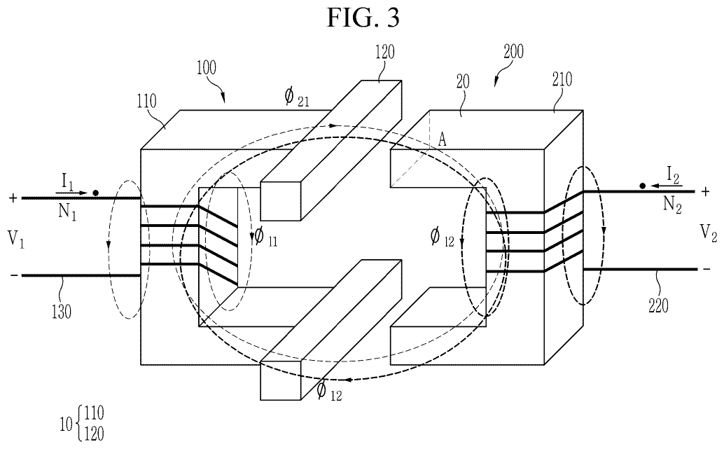

FIG. 3 is a diagram schematically illustrating transmission and reception pads of a wireless charging system for an electric vehicle according to an example embodiment of the present disclosure.

Referring to FIG. 3, the transmission pad 10 may be formed to be asymmetric to the reception pad 20. The transmission pad 10 can have a double pole resonant pad structure, and the double pole resonant pad structure can include a first magnet 110, and a pair of second magnets 120 coupled to an end of the first magnet 110.

In the first magnet 110, both ends may be formed to protrude in a height direction of the vehicle 5, and a first coil 130 may be wound on a center portion. When current flows through the first coil 130 wound on the first magnet 110, a magnetic field can be formed in the first magnet 110 and the second magnet 120.

The second magnets 120 may be a bar shape coupled to both ends of the first magnet 110 in a form to extend vertically to a protruding direction of the first magnet 110. That is, the second magnet 120 may be in a form to extend in a width direction of the vehicle 5.

The reception pad 20 can include a third magnet 210 opposite to the first magnet 110. The third magnet 210 may be formed to protrude in the height direction of the vehicle 5 toward the first magnet 110. A second coil 220 may be wound on a center portion of the third magnet 210. When current flows through the second coil 220, a magnetic field may be formed in the third magnet 210.

In this case, a double pole resonant pad structure may be designated to satisfy a maximum transfer power upon short-distance wireless charging. Maximum power transferred from the transmitter 100 to the receiver 200 may be determined by coupling of the magnetic field of the transmission pad 10 and the magnetic field of the reception pad 20. The maximum transfer power may be determined by applying magnetic inductance L and mutual inductance M in an inductive power transfer (IPT) mutual bonding model.

The wireless charging system may further include a pad position sensor that senses positions of the transmission pad 10 and the reception pad 20 in a vehicle width direction. The pad position sensor and an actuator at the transmitter side can be jointly used to reduce a vehicle width-direction core size of the transmission pad 10, alleviate asymmetry of the transmission pad 10, and reduce a volume and cost.

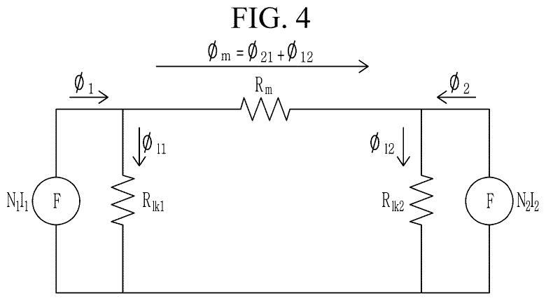

FIG. 4 is a diagram illustrating a magnetic equivalent circuit model of transmission and reception pads of a wireless charging system for an electric vehicle according to an example embodiment of the present disclosure.

Referring to FIGS. 3 and 4, to calculate the maximum transfer powers of the transmission and reception pads 10 and 20, placement forms of the transmission and reception pads 10 and 20 illustrated in FIG. 3 may be replaced with the magnetic equivalent circuit model of FIG. 4.

In the magnetic equivalent circuit of FIG. 4, an ampere primary circuit law and a Faraday's law can be applied to generate a magnetic flux that time-varies by current of coils 130 and 220, and induce a counter electromotive force by the time-varied magnetic flux.

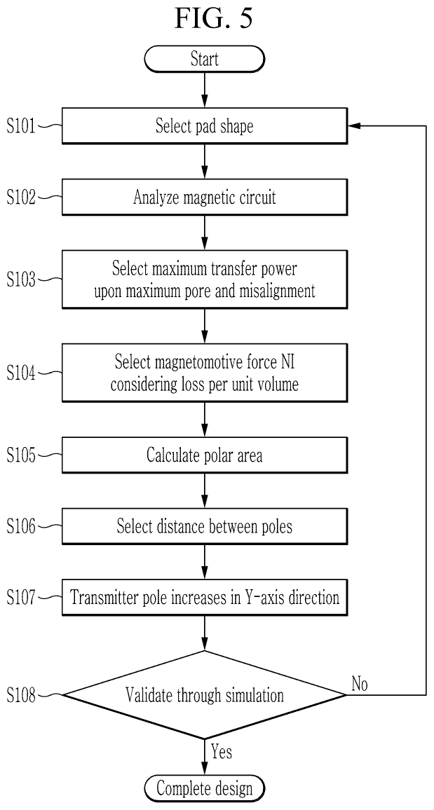

FIG. 5 is a flowchart illustrating a shape design method of a resonant pad of a wireless charging system for an electric vehicle according to an example embodiment of the present disclosure.

Referring to FIG. 5, first, schematic shapes of the pads 10 and 20 can be selected to design the shape of the resonant pad of the wireless charging system (operation S101). In an example embodiment of the present disclosure, shapes of the transmission and reception pads 10 and 20 can be selected, which can be constituted by a transmission pad 10 having a double pole resonant pad structure including the first magnet 110 and the second magnet 120, and a reception pad 20 including the third magnet 210 disposed to face the transmission pad 10.

Thereafter, a magnetic circuit can be analyzed (operation 5102). In this case, the magnetic circuit analysis may be performed by a magnetic equivalent circuit induction model of the transmission and reception pads 10 and 20 by an IPT ruling equation illustrated in FIGS. 3 and 4. When current I is made to flow after the coils 130 and 220 are wound on an iron core N turns, a magnetic flux f can be generated in the iron core. The magnetic flux can be rotated through the iron core, that is, a closed circuit. The magnetic flux can flow along the iron core, and can be in proportion to NI. NI can be referred to as magnetomotive force. The flow of the magnetic flux can be interrupted by magnetic resistance Rm. That is, the magnetic flux can be in inverse proportion to the magnetic resistance, and can be in proportion to the magnetomotive force F.

Thereafter, the maximum transfer power can be selected based upon a maximum pore and misalignment of the transmission and reception pads 10 and 20 (operation S103).

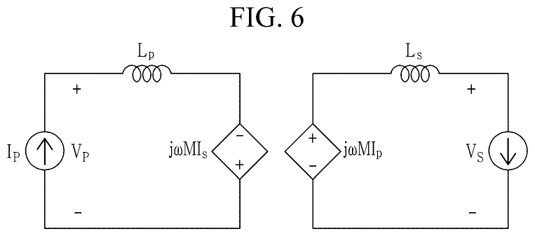

FIG. 6 is a diagram illustrating a mutual combination model equivalent circuit of the transmission and reception pads for magnetic circuit analysis in the shape design method of the resonant pad in the wireless charging system for an electric vehicle according to an example embodiment of the present disclosure.

The maximum transfer power may be modeled by applying magnetic inductances L_{P} and L_{S}, and mutual inductances M in the mutual bonding model. The maximum transfer power of the transmission and reception pads 10 and 20 may be determined by magnetic field bonding between the transmission and reception pads 10 and 20, and the maximum transfer power of the transmission and reception pads 10 and 20 may be obtained by a multiplication of a voltage V_{oc} and a current I_{sc}. This may be expressed by Equation 1 below.

$${V}_{OC} {I}_{SC} = ω ( {M}^{2} / {L}_{S} ) {I}_{P}^{2} = ω {L}_{P} {k}^{2} {I}_{P}^{2} \qquad [ Equation 1 ]$$

Thereafter, the magnetomotive force NI considering loss per unit volume can be selected (operation S104).

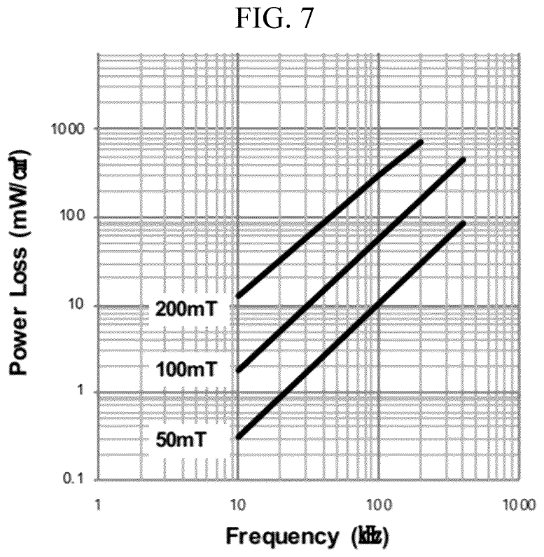

FIG. 7 is a diagram illustrating a loss per core unit volume for magnetomotive force selection in the shape design method of the resonant pad in the wireless charging system for an electric vehicle according to an example embodiment of the present disclosure.

Referring to FIGS. 4 and 7, a core magnetic flux density Ø₁ by current at the transmitter 100 side can be a sum of Ø₁ and Ø_{|1}, and this becomes a value of B_{avg}*A, and this becomes (N₁I₁/2kl_{g})*μₒA. In this case, B is (N₁I₁/2kl_{g})*μₒ.

The loss per unit volume Pᵥ can be approximately 200 kW/m³ upon natural heat dissipation, and approximately 500 kW/m³ upon active heat dissipation, as illustrated in FIG. 7. In the case of an embodiment of the present disclosure, Bₘₐₓ may be 150 mT.

The magnetomotive force may be modeled as Equation 2 below.

$${N}_{1} {I}_{P} = {kl}_{g} {B}_{max} / {μ}_{0} \qquad [ Equation 2 ]$$

The magnetomotive force considering the loss per unit volume may be selected by substituting the value of Bₘₐₓ into Equation 2 above.

Thereafter, the polar area can be calculated (operation S105).

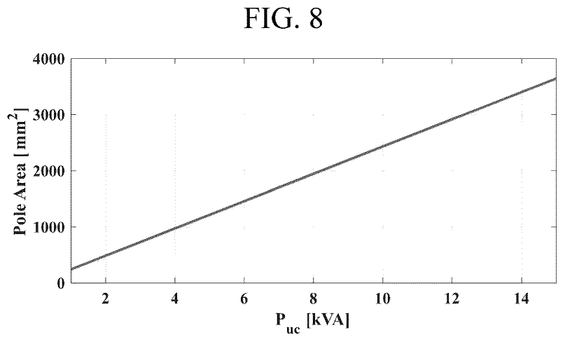

FIG. 8 is an example diagram for calculating a polar area in the shape design method of the resonant pad in the wireless charging system for an electric vehicle according to an example embodiment of the present disclosure.

The polar area may be modeled as Equation 3 below.

$$A = 2 {l}_{g} {P}_{uc} / k ω ( {N}_{1} {I}_{P} ) 2 {μ}_{0} \qquad [ Equation 3 ]$$

In this case, k may represent a minimum bonding coefficient in a given pore d and a misalignment situation, and a maximum transfer power may be corrected even in a worst bonding situation. The value of N₁Iₚ can adopt the magnetomotive force value selected above.

Thereafter, a distance between poles can be selected (operation S106).

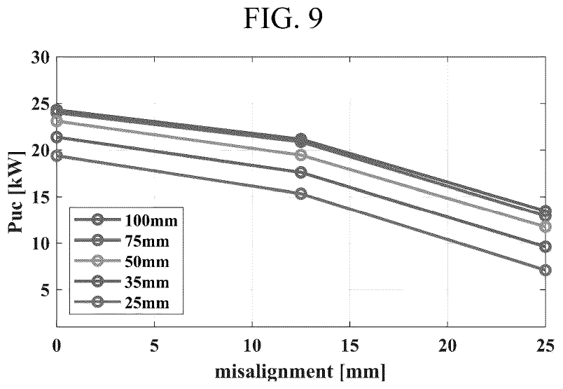

FIG. 9 is an example diagram for selecting a distance between poles in the shape design method of the resonant pad of the wireless charging system for an electric vehicle according to an example embodiment of the present disclosure.

Referring to FIG. 9, in a case where the polar area is constant, the case represents a change in transfer power according to a distance between poles. There can be a tendency in which as the distance between the poles is smaller, leakage magnetic resistance Rₗₖ increases, a bonding coefficient k decreases, and transfer power is reduced. However, because the distance between the poles may not be selected to be large unconditionally, the shape of the resonant pad can be designed through an FEM simulation.

Thereafter, the transmission pad 10 can be set asymmetrically in a vehicle width direction (operation S107).

Referring to FIGS. 3 and 4, a leakage magnetic flux Øₗ₁ at the transmitter 100 side can be increased due to reduction of the magnetic resistance. An inductance L1 at the transmitter 100 side and a leaked inductance can increase.

A magnetic resistance Rm between the transmitter 100 side and the receiver 200 side can be almost constant. Mutual magnetic fluxes Ø₂₁ and Ø₁₁ can be maintained, and the maximum transfer power selected in the above design can be enabled to be maintained.

Thereafter, validation can be performed through an FEM simulation (operation S108). In the validation through the FEM simulation (operation S108), it may be validated whether a target maximum transfer power is satisfied in the misalignment condition of the transmission pad 10 and the reception pad 20 in the vehicle width direction.

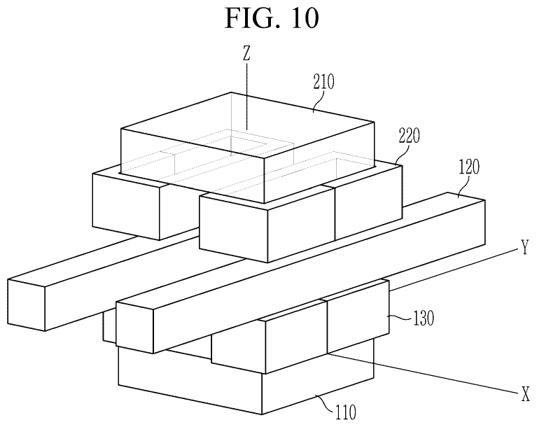

FIGS. 10 to 12 are example diagrams, and each can be for validation through a simulation in the shape design method of the resonant pad in the wireless charging system for an electric vehicle according to an example embodiment of the present disclosure.

The first magnet 110, the first coil 130, and the second magnet 120 can be disposed as the transmission pad 10. The second coil 220 can be disposed to face the second magnet 120. The third magnet 210 can be disposed on the second coil 220 as the reception pad 20. The transmission pad 10 and the reception pad 20 can be designated in an asymmetric form.

Further, in the transmitter 100, a Y-axis direction asymmetric design of the transmission pad 10 can be performed according to the vehicle width (Y-axis)-direction misalignment condition.

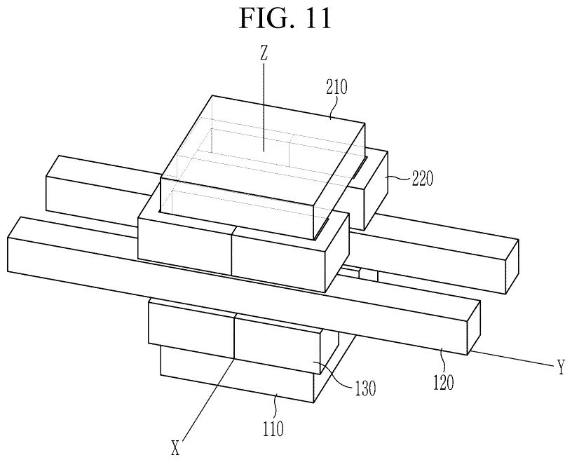

As an example, in Y-axis misalignment condition +/−100 mm condition illustrated in FIGS. 10 and 11, the transmitter 100 can be increased by 200 mm in a Y-axis direction. That is, the polar area of the transmitter 100 can be set to 25 mm in an X-axis direction, and 300 mm in the Y-axis direction, and the polar area of the receiver 200 side can be set to 25 mm in the X-axis direction and 100 mm in the Y-axis direction. Further, in a Z-axis direction, the polar area of the transmitter 100 can be set to 75 mm and the polar area of the receiver 200 can be set to 50 mm.

The asymmetric misalignment condition, inductances Lₚ and Lₛ according to Y-axis misalignment, and the mutual inductance M can be derived.

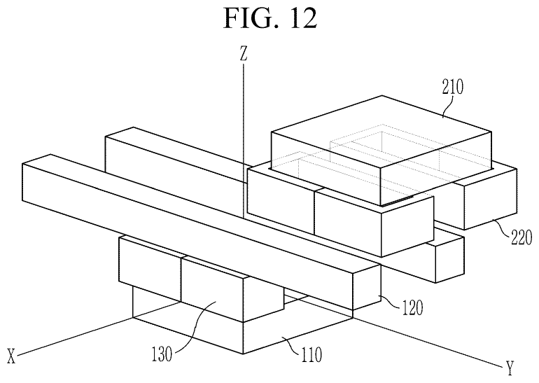

In a worst misalignment condition illustrated in FIG. 12, it can be validated whether the maximum transfer power can be satisfied. In FIG. 12, in a condition in which the polar area of the transmitter 100 is +/−25 mm in the X-axis direction, +/−100 mm in the Y-axis direction, and 10 mm in the Z-axis direction, it can be validated whether the target maximum transfer power (e.g., 10 kVA) can be achieved.

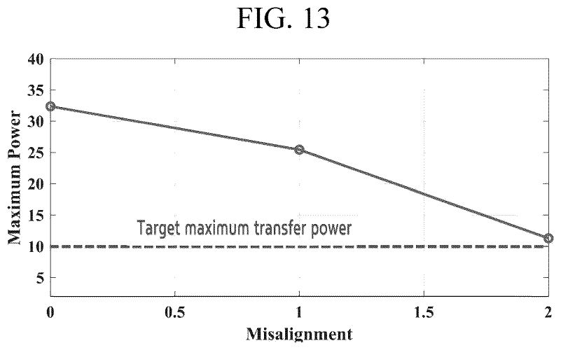

FIG. 13 is a diagram illustrating maximum transmission power in a misalignment situation in the shape design method of the resonant pad in the wireless charging system for an electric vehicle according to an example embodiment of the present disclosure.

As illustrated in FIG. 13, it can be seen that when a pore d of 10 mm is formed between the transmission pad 10 and the reception pad 20, the target maximum transfer power (e.g., 10 kVA) may be achieved in the case of regulating to 12.5 mm in the X-axis direction and 50 mm in the Y-axis direction (e.g., Misalignment=1) and in the case of +/−25 mm in the X-axis direction and +/−100 mm in the Y-axis direction (e.g., Misalignment=2) with respect to the maximum transfer power according to a misalignment degree.

Accordingly, with respect to a maximum design pad specification, an area of the receiver 200 may be set to 2500 mm², and the receiver 200 may be set to 100 mm in the X-axis direction, 100 mm in the Y-axis direction, and 50 mm in the Z-axis direction, and the area of the transmitter 100 may be set to 2500 mm², and the transmitter 100 may be set to 100 mm in the X-axis direction, 300 mm in the Y-axis direction, and 75 mm in the Z-axis direction, for example.

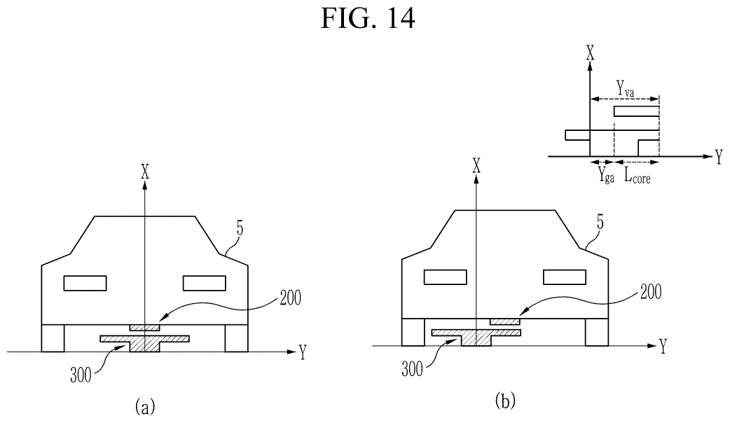

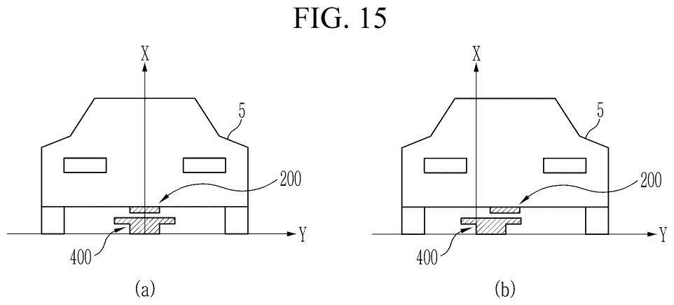

FIG. 14 is a diagram illustrating a case of applying only an asymmetric design without an actuator in the wireless charging system for an electric vehicle according to an example embodiment of the present disclosure, and FIG. 15 is a diagram illustrating a case of applying the asymmetric design by using the actuator in the wireless charging system for an electric vehicle according to an example embodiment of the present disclosure.

As illustrated in FIG. 14, when only the asymmetric design is applied without the actuator 40, a Y axis-direction core size L_{core} may be increased. However, as illustrated in FIG. 15, when Y axis-direction control is possible by using the actuator 40, the Y axis-direction core size may be reduced, and as a result, asymmetry of the transmitter 100 may be alleviated, and the volume and cost may be reduced.

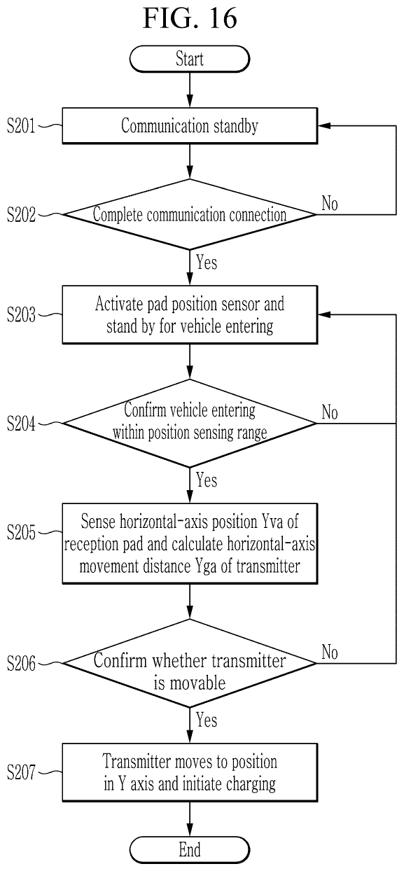

FIG. 16 is a flowchart illustrating a wireless charging process in a case of using a Y-axis positional sensor in the wireless charging system for an electric vehicle according to an example embodiment of the present disclosure.

During communication standby of a transmitter 100 and a receiver 200 (operation S201), when it is confirmed whether communication connection is completed (operation S202), a pad position sensor can be activated, and a vehicle 5 can stand by for entering a charging system (operation S203).

Thereafter, the vehicle 5 can enter, and it can be confirmed whether the vehicle 5 enters within a pad position sensor position range (operation S204).

When it is confirmed that the vehicle 5 enters within the pad position sensor position range, a horizontal-axis position Yᵥₐ of the reception pad 20 and a horizontal-axis movement distance Y_{ga} of the transmitter 100 can be calculated (operation S205), and it can be confirmed whether the transmitter 100 is movable (operation S206). When an absolute of the horizontal-axis movement distance Y_{ga} of the transmitter 100 is smaller than a maximum horizontal-axis movement distance Y_{ga,max} of the transmitter 100, Y axis-direction movement and charging of the transmitter 100 can be initiated (operation S207).

By using the Y-axis positional sensor, the asymmetry alleviation of the transmitter 100, and reduction of the volume and the cost according to the reduction in the Y axis-direction core size may be achieved similarly to the actuator 40.

As described above, according to an example embodiment of the present disclosure, a transmitter can be configured by a double pole pad, and a size of a transverse core of the transmission pad can be configured asymmetrically (or wider than) to a reception pad by considering a transverse allowable deviation between a transmission pad and the reception pad for wireless charging of an electric vehicle, so the need for transverse movement of the vehicle can be removed or minimized for positional alignment of the transmission and reception pads, thereby potentially simplifying a charging system.

With use of an embodiment, stress felt by a customer for positional alignment of the transmission and reception pads can be minimized, and system design robust to misalignment can be possible.

With use of an embodiment, by maintaining pores between the transmission and reception pads in a short distance, volumes of the transmission and reception pads can be reduced, and a power transmission capability can be increased and charging efficiency can be enhanced.

With use of an embodiment, an actuator for reduction of the pores between the transmission and reception pads can be provided to reduce installation cost of the transmitter or the receiver, and minimize the complexity of the actuator for positional control through asymmetric design of the transmission pad.

With use of an embodiment, use of a variable element in a receiver-side compensation circuit can be minimized by minimizing a circuit variable change according to a misalignment situation to simplify a receiver structure, and reduce cost and a receiver volume.

While the present disclosure has been described in connection with what is presently considered to be practical example embodiments, it can be understood that embodiments of the present disclosure are not necessarily limited to the disclosed example embodiments. On the contrary, the present disclosure is intended to cover various modifications and equivalent arrangements included within the spirit and scopes of the appended claims.

What is claimed is:

1. A wireless charging system for an electric vehicle, comprising:
a transmitter including a transmission pad installed on an exterior of the vehicle, wherein the transmitter is configured to generate an electromagnetic field by receiving energy; and
a receiver including a reception pad installed inside the vehicle, wherein the reception pad is disposed and configured to face the transmission pad, wherein the receiver is configured to induct a voltage by the electromagnetic field generated by the transmission pad and charge a battery of the vehicle, wherein the transmission pad is configured to transmit a specified output even though the transmission pad is formed to be asymmetric with respect to the reception pad in a width direction of the vehicle.

2. The system of claim 1, wherein the receiver includes a power conversion circuit configured to convert a power received through the reception pad into a DC voltage.

3. The system of claim 1, further comprising an actuator installed inside the vehicle, wherein the actuator is configured to adjust a vertical distance between the transmission pad and the reception pad.

4. The system of claim 3, wherein the actuator is configured such that the vertical distance between the transmission pad and the reception pad can be adjusted as an interval of 100 mm or less.

5. The system of claim 1, further comprising a parking block installed separate from the vehicle, wherein the parking block is configured to adjust a longitudinal alignment of the vehicle.

6. The system of claim 1, wherein the transmission pad comprises a double pole resonant pad structure, and wherein the double pole resonant pad structure comprises:
a first magnet formed to protrude in a height direction of the vehicle, wherein the first magnet is wound with a first coil; and
a pair of second magnets coupled to ends of the first magnet in a form to further protrude in the height direction.

7. The system of claim 6, wherein the reception pad comprises a third magnet, wherein the third magnet is configured to be disposed opposite to the first magnet and to protrude toward the first magnet, and wherein the third magnet is wound with a second coil.

8. The system of claim 7, wherein the double pole resonant pad structure is configured to satisfy a specified transfer power for short-distance wireless charging.

9. The system of claim 1, further comprising a pad position sensor configured to sense relative positions of the transmission pad and the reception pad in a vehicle width direction.

10. A shape design method of a resonant pad of a wireless charging system for an electric vehicle, comprising:
selecting shapes of a transmission pad and a reception pad;
analyzing a magnetic circuit including the transmission pad and the reception pad;
selecting a maximum transfer power based on a maximum vertical distance between the transmission pad and the reception pad, and based on horizontal misalignment between the transmission pad and the reception pad;
selecting a magnetomotive force considering to a loss per unit volume;
calculating a polar area;
selecting a first distance between poles;
setting the transmission pad asymmetrically in a vehicle width direction relative to the reception pad; and
validating through a simulation.

11. The method of claim 10, wherein the selecting of the shapes of the transmission pad and the reception pad comprises selecting the shapes of the transmission pad and the reception pad such that the shape of the transmission pad is asymmetrical with respect to the reception pad, wherein the transmission pad has a double pole resonant pad structure.

12. The method of claim 10, wherein the analyzing of the magnetic circuit is performed by magnetic equivalent circuit induction of the transmission pad and the reception pad by an inductive power transfer (IPT) ruling equation.

13. The method of claim 10, wherein the selecting of the maximum transfer power comprises modeling the maximum transfer power using Equation 1:
$${V}_{OC} {I}_{SC} = ω ( {M}^{2} / {L}_{S} ) {I}_{P}^{2} = ω {L}_{P} {k}^{2} {I}_{P}^{2} \qquad ( Equation 1 )$$
wherein V_{oc} is voltage, I_{sc} is current, o is frequency of alternating current, M is mutual inductances, L_{P} is self-inductance of a primary coil related to the transmission pad, L_{S} is self-inductance of a secondary coil related to the reception pad, I_{P} is current in the primary coil, and k is a coupling coefficient between the primary coil and the secondary coil.

14. The method of claim 10, wherein, in the selecting of the magnetomotive force considering the loss per unit volume, the magnetomotive force is modeled as Equation 2:
$${N}_{1} {I}_{P} = {kl}_{g} {B}_{max} / {μ}_{0} \qquad ( Equation 2 )$$
wherein N₁ is a number of turns of a primary coil related to the transmission pad, I_{P} is a current in the primary coil, l_{g} is a given vertical distance between the transmission pad and the reception pad, k is a minimum bonding coefficient in the given vertical distance between the transmission pad and the reception pad and for a misalignment situation, Bₘₐₓ is a maximum magnetic flux density representing a peak magnetic field strength in an air gap between the transmission pad and the reception pad, and μₒ is a constant representing permeability of free space at the air gap.

15. The method of claim 10, wherein, in the calculating of the polar area, the polar area is modeled as Equation 3:
$$A = 2 {l}_{g} {P}_{uc} / k ω ( {N}_{1} {I}_{P} ) 2 {μ}_{0} \qquad ( Equation 3 )$$
wherein A is a cross-sectional area through which magnetic flux passes, l_{g} is a given vertical distance between the transmission pad and the reception pad, k is a minimum bonding coefficient in the given vertical distance between the transmission pad and the reception pad and for a misalignment situation, P_{uc} is uncoupled power that represents power transferred when the transmission pad and the reception pad are not ideally coupled due to misalignment, separation, or misalignment and separation, ω is frequency of alternating current, N₁ is a number of turns of a primary coil related to the transmission pad, I_{P} is a current in the primary coil, and μₒ is a constant representing permeability of free space at an air gap between the transmission pad and the reception pad.

16. The method of claim 10, wherein, in the selecting of the first distance between the poles, the first distance between the poles is set through a finite element method (FEM) simulation.

17. The method of claim 10, wherein the setting of the transmission pad asymmetrically in the vehicle width direction comprises setting a second magnet at one side to be longer by 200 mm in the vehicle width direction.

18. The method of claim 10, wherein the validating through the simulation comprises validating whether a target maximum transfer power is satisfied in a misalignment condition of the transmission pad and the reception pad in the vehicle width direction.

19. A wireless charging system for a vehicle, comprising:
a transmitter including a transmission pad configured to be installed separate from the vehicle, wherein the transmitter is configured to generate an electromagnetic field by receiving energy; and
a receiver including a reception pad installed on the vehicle, wherein the reception pad is configured to be disposed to face the transmission pad while the vehicle is over the transmitter, wherein the receiver is configured to induct a voltage by the electromagnetic field generated by the transmission pad and charge a battery of the vehicle, wherein the transmission pad is wider in a vehicle width direction than the reception pad.

20. The system of claim 19, wherein the transmission pad comprises a double pole resonant pad structure, and wherein the double pole resonant pad structure comprises:
a generally U-shaped first magnet formed to protrude in a height direction of the vehicle, wherein the first magnet is wound with a first coil, and
a pair of generally bar-shaped second magnets coupled to ends of the first magnet in a form to further protrude in the height direction, wherein the second magnets have a first width in the vehicle width direction; and
wherein the reception pad comprises a generally U-shaped third magnet, wherein the third magnet is configured to be disposed opposite to the first magnet and to protrude toward the first magnet while the receiver is over the transmitter, wherein the third magnet is wound with a second coil, and wherein a measurement distance across protruding tips of the third magnet in the vehicle width direction has a second width, and wherein the first width is greater than the second width.
